(19) United States
(12) Patent Application Publication
(10) Pub. No.: US 2011/0234585 A1
(43) Pub. Date: Sep. 29, 2011

(54) METHOD AND APPARATUS FOR PROCESSING 3D IMAGES IN MOBILE TERMINAL

(75) Inventor: Seong Geun KWON, Daegu (KR)

(73) Assignee: SAMSUNG ELECTRONICS CO. LTD., Suwon-si (KR)

(21) Appl. No.: 13/069,686

(22) Filed: Mar. 23, 2011

(30) Foreign Application Priority Data
Mar. 24, 2010 (KR) 10-2010-0026351

(51) Int. Cl. G06T 15/00

(52) U.S. Cl. 345/419

(57) ABSTRACT

A 3 Dimensional (3D) image processing method and apparatus for a mobile terminal are provided. The method enables the mobile terminal to reconstruct side-by-side 3D images. The method includes, receiving a side-by-side 3D image including vertical lines of pixels, generating a left frame to form a left image and a right frame to form a right image by copying lines of the left half of the side-by-side 3D image to even-numbered lines of the left frame and copying lines of the right half of the side-by-side 3D image to odd-numbered lines of the right frame, completing the left image and the right image by interpolating existing lines of the left frame and the right frame, and generating a 3D image frame by combining the left image and the right image, and displaying the 3D image frame. Hence, the mobile terminal may provide higher quality 3D images to the user.

### PRIORITY

This application claims the benefit under 35 U.S.C. §119(a) of a Korean patent application filed on Mar. 24, 2010 in the Korean Intellectual Property Office and assigned Serial No. 10-2010-0026351, the entire disclosure of which is hereby incorporated by reference.

### BACKGROUND OF THE INVENTION

1. Field of the Invention

The present invention relates to a 3 Dimensional (3D) image processing method and apparatus for a mobile terminal. More particularly, the present invention relates to a method and an apparatus for enabling a mobile terminal to reconstruct and process three dimensional images in a side-by-side format.

2. Description of the Related Art

With rapid popularization, mobile terminals have become a necessity of modern life. Mobile terminals have evolved into multimedia communication devices that can provide not only basic voice communication services but also various data transmission and supplementary services.

Recent advances in a 3 Dimensional (3D) stereoscopic imaging technology have given rise to development of mobile terminals capable of outputting 3D stereoscopic images. In response to the transition to digital broadcasting, efforts have been made to provide 3D stereoscopic imaging capabilities to television sets and information terminals.

3D stereoscopic imaging is achieved through the principle of stereo vision based on two eyes. Binocular disparity caused by the distance between the two eyes of about 65 mm is a key factor to the 3D effect. Different 2 Dimensional (2D) images seen by the left and right eyes are transferred through the retinas to the brain, which fuses the 2D images together into a 3D stereoscopic image providing depth and 3D perception.

A 3D content may include multiple stereoscopic frames coded in various 3D formats. For example, in the interlaced format, alternating lines of the left eye image and the right eye image are placed in the stereoscopic frame. In the side-by-side format, the left eye image and the right eye image are placed in the left half and the right half of the stereoscopic frame. In the top-and-bottom format, the left eye image and the right eye image are placed in the top half and bottom half of the stereoscopic frame.

Stereoscopic 3D broadcast services of the related art employ the side-by-side format. However, in the side-by-side format, placing the left eye image and the right eye image in a single frame may cause image data loss and picture quality degradation. Hence, it is necessary to develop a means that can improve the picture quality of stereoscopic 3D images in a 3D broadcast service employing the side-by-side format.

### SUMMARY OF THE INVENTION

An aspect of the present invention is to address at least the above-mentioned problems and/or disadvantages and to provide at least the advantages described below. Accordingly, an aspect of the present invention is to provide a method and an apparatus that can improve the picture quality of stereoscopic 3 Dimensional (3D) images in a mobile terminal.

In accordance with an aspect of the present invention, a method for processing 3D images in a mobile terminal is provided. The method includes, receiving a side-by-side 3D image including vertical lines of pixels, generating a left frame to form a left image and a right frame to form a right image by copying lines of the left half of the side-by-side 3D image to even-numbered lines of the left frame and copying lines of the right half of the side-by-side 3D image to odd-numbered lines of the right frame, completing the left image and the right image by interpolating existing lines of the left frame and the right frame, and generating a 3D image frame by combining the left image and the right image, and displaying the 3D image frame.

In accordance with another aspect of the present invention, a mobile terminal capable of processing 3D images is provided. The mobile terminal includes, a display unit for displaying a 3D image, a line arranger for generating, for a side-by-side 3D image including vertical lines of pixels, a left frame to form a left image and a right frame to form a right image by copying lines of the left half of the side-by-side 3D image to even-numbered lines of the left frame and for copying lines of the right half of the side-by-side 3D image to odd-numbered lines of the right frame, a line interpolator for completing the left image and the right image by interpolating existing lines of the left frame and the right frame, a Left-Right (L-R) image synthesizer for generating a 3D image frame by combining the left image and the right image, and an image output controller for controlling the display unit to display the generated 3D image frame.

In an exemplary implementation, the user of a mobile terminal may enjoy higher-quality stereoscopic 3D images.

Other aspects, advantages, and salient features of the invention will become apparent to those skilled in the art from the following detailed description, which, taken in conjunction with the annexed drawings, discloses exemplary embodiments of the invention.

### BRIEF DESCRIPTION OF THE DRAWINGS

The above and other aspects, features, and advantages of certain exemplary embodiments of the present invention will be more apparent from the following description taken in conjunction with the accompanying drawings, in which:

FIG. 1 is a block diagram of a mobile terminal capable of processing 3 Dimensional (3D) images according to an exemplary embodiment of the present invention;

FIG. 2 is a flowchart of a 3D image processing method for a mobile terminal according to an exemplary embodiment of the present invention;

FIG. 3 is a flowchart of generating left and right images from a side-by-side 3D image according to an exemplary embodiment of the present invention;

FIGS. 4A and 4B illustrate generation of left and right images from a side-by-side 3D image according to an exemplary embodiment of the present invention;

FIG. 4C illustrates a reconstructed 3D image according to an exemplary embodiment of the present invention;

FIGS. 5A and 5B illustrate a comparison between an image reconstructed using a method of the related art and an image reconstructed according to an exemplary embodiment of the present invention;

FIG. 6 illustrates generation of a side-by-side 3D image according to an exemplary embodiment of the present invention;

FIG. 7A illustrates left and right images generated according to the related art; and

FIG. 7B illustrates a reconstructed 3D image generated by combining left and right images according to the related art.

Throughout the drawings, it should be noted that like reference numbers are used to depict the same or similar elements, features, and structures.

### DETAILED DESCRIPTION OF EXEMPLARY EMBODIMENTS

The following description with reference to the accompanying drawings is provided to assist in a comprehensive understanding of exemplary embodiments of the invention as defined by the claims and their equivalents. It includes various specific details to assist in that understanding but these are to be regarded as merely exemplary. Accordingly, those of ordinary skill in the art will recognize that various changes and modifications of the embodiments described herein can be made without departing from the scope and spirit of the invention. In addition, descriptions of well-known functions and constructions may be omitted for clarity and conciseness.

The terms and words used in the following description and claims are not limited to the bibliographical meanings, but, are merely used by the inventor to enable a clear and consistent understanding of the invention. Accordingly, it should be apparent to those skilled in the art that the following description of exemplary embodiments of the present invention is provided for illustration purpose only and not for the purpose of limiting the invention as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

By the term “substantially” it is meant that the recited characteristic, parameter, or value need not be achieved exactly, but that deviations or variations, including for example, tolerances, measurement error, measurement accuracy limitations and other factors known to those of skill in the art, may occur in amounts that do not preclude the effect the characteristic was intended to provide.

Exemplary embodiments of the present invention focus on a mobile terminal. However, exemplary embodiments of the present invention are not limited thereto and are applicable to any device capable of outputting stereoscopic 3 Dimensional (3D) images. The mobile terminal of the present invention may include a mobile communication terminal, a Portable Multimedia Player (PMP), a Personal Digital Assistant (PDA), a smart phone, or a Moving Picture Experts Group (MPEG)-1 or MPEG-2 Audio Layer 3 (MP3) player. Here, the mobile communication terminal may include an International Mobile Telecommunications 2000 (IMT 2000) terminal, a Wideband Code Division Multiple Access (WCDMA) terminal, a Global System for Mobile Communications (GSM)/General Packet Radio Services (GPRS) terminal, or a Universal Mobile Telecommunications System (UMTS) terminal.

The 3D image processing method focuses on 3D image content transmitted using a Digital Multimedia Broadcasting (DMB) service. However, an exemplary embodiment of the present invention is not limited thereto, and is applicable to 3D image content stored in the storage unit of a mobile terminal.

In addition, the 3D image processing method focuses on side-by-side 3D images. However, an exemplary embodiment of the present invention is not limited thereto, and is applicable to top-and-bottom 3D images.

An exemplary embodiment of the present invention relates to a method in which a mobile terminal receives a 3D image in the side-by-side format and reconstructs and processes the 3D image to generate a side-by-side 3D image.

A left stereo camera and a right stereo camera separated by a given distance are simultaneously used to capture images of the same target object. The left stereo camera produces a left view image, and the right stereo camera produces a right view image. A 3D imaging apparatus may be used to create a side-by-side 3D image using the left view image and the right view image.

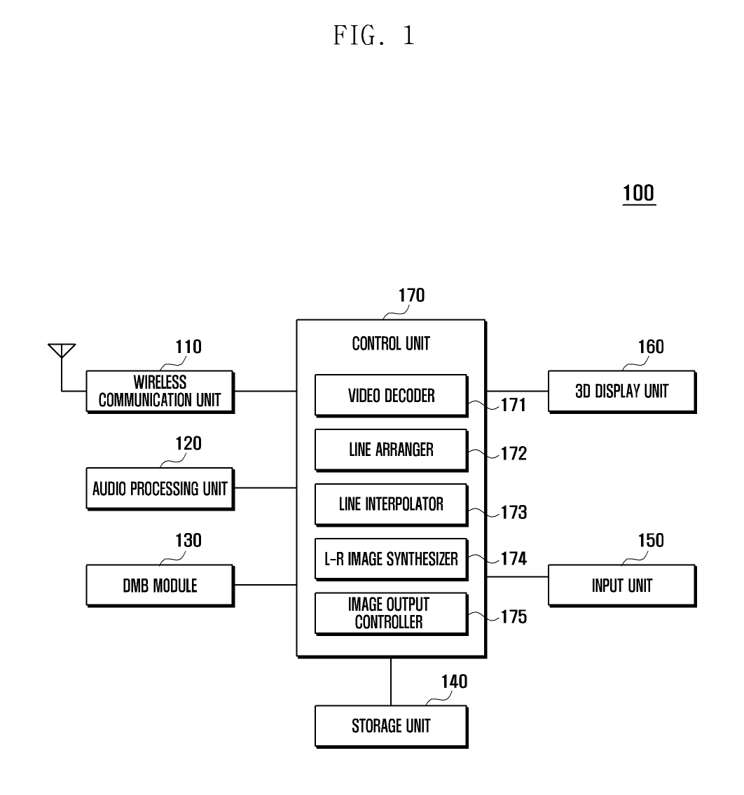

FIGS. 1 through 6, discussed below, and the various exemplary embodiments used to describe the principles of the present disclosure in this patent document are by way of illustration only and should not be construed in any way that would limit the scope of the disclosure. Those skilled in the art will understand that the principles of the present disclosure may be implemented in any suitably arranged communications system. The terms used to describe various embodiments are exemplary. It should be understood that these are provided to merely aid the understanding of the description, and that their use and definitions in no way limit the scope of the invention. Terms first, second, and the like are used to differentiate between objects having the same terminology and are in no way intended to represent a chronological order, unless where explicitly state otherwise. A set is defined as a non-empty set including at least one element.

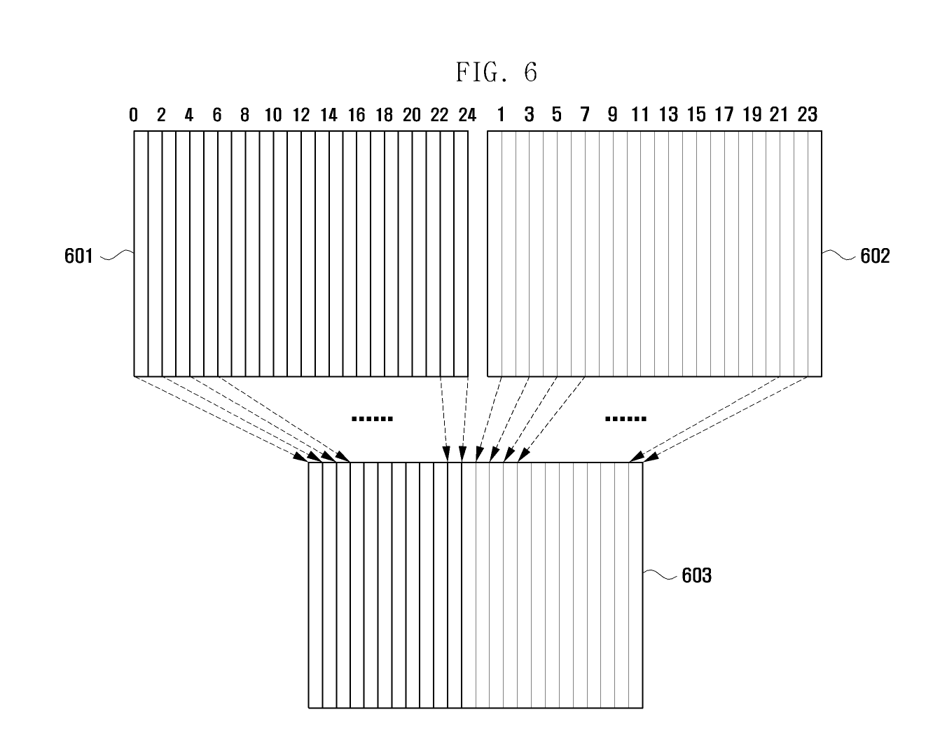

FIG. 6 illustrates generation of a side-by-side 3D image according to an exemplary embodiment of the present invention.

Referring to FIG. 6, a left view image 601 and a right view image 602 are used to produce a side-by-side 3D image 603. Each of the left view image 601 and the right view image 602 includes 25 vertical lines of pixels. Even-numbered lines (0, 2, 4, 6, 8, 10, 12, 14, 16, 18, 20, 22 and 24) of the left view image 601 are placed in the left half of the side-by-side 3D image 603, and odd-numbered lines (1, 3, 5, 7, 9, 11, 13, 15, 17, 19, 21 and 23) of the right view image 602 are placed in the right half of the side-by-side 3D image 603.

The side-by-side 3D image 603 may be created using even-numbered lines of the left view image 601 and odd-numbered lines of the right view image 602 according to the specification of a related 3D broadcasting service. The side-by-side 3D image 603 may also be created using odd-numbered lines of the left view image 601 and even-numbered lines of the right view image 602 depending upon the specification of a 3D broadcasting service.

Side-by-side 3D images produced by the above procedure are encoded in a preset format, such as H.264, and the encoded 3D images are transmitted through a DMB or a wireless network to mobile terminals. Next, a description is given of a process by which a mobile terminal receives a broadcast signal carrying an encoded side-by-side 3D image and processes the encoded side-by-side 3D image.

FIG. 1 is a block diagram of a mobile terminal capable of processing 3D images according to an exemplary embodiment of the present invention.

Referring to FIG. 1, a mobile terminal 100 includes a wireless communication unit 110, an audio processing unit 120, a DMB module 130, a storage unit 140, an input unit 150, a 3D display unit 160, and a control unit 170. The wireless communication unit 110 sends and receives data for wireless communication of the mobile terminal 100. The wireless communication unit 110 may include a radio frequency transmitter for upconverting the frequency of a signal to be transmitted and amplifying the signal, and a radio frequency receiver for low-noise amplifying a received signal and downconverting the frequency of the signal. The wireless communication unit 110 may receive data through a wireless channel and forward the received data to the control unit 170, and may transmit data from the control unit 170 through the wireless channel. More particularly, the wireless communication unit 110 may receive stereoscopic image data from an external server or another mobile terminal.

The audio processing unit 120 may include a coder/decoder (codec). The codec may include a data codec for processing packet data, and an audio codec for processing an audio signal, such as a voice signal. The audio processing unit 120 converts a digital audio signal into an analog audio signal through the audio codec and outputs the analog audio signal to a receiver or a speaker, and also converts an analog audio signal from a microphone into a digital audio signal through the audio codec.

The DMB module 130 receives a DMB signal broadcast by a broadcasting station. Preferably, the DMB module 130 includes a satellite DMB receiver. However, a terrestrial DMB receiver may also be employed. The broadcasting station transmits a broadcast signal carrying 3D image content to a geostationary satellite, using Code Division Multiplexing (CDM) and Time Division Multiplexing (TDM) through the Kᵤ band of 12 to 18 GHz. Upon reception of the broadcast signal, the geostationary satellite transmits back the received broadcast signal through the S band of 1550 to 5200 MHz and the Kᵤ band. The Kᵤ band signal is received by a gap filler covering a shadow area and is converted into an S band signal. Hence, the DMB module 130 receives the broadcast signal as an S band signal transmitted by the geostationary satellite or gap filler.

The storage unit 140 stores programs and data necessary for the operation of the mobile terminal 100, and may include a program zone and a data zone. The storage unit 140 may include a volatile storage media, a non-volatile storage media, or a combination thereof. The volatile storage media may include semiconductor memories, such as a Random Access Memory (RAM), a Dynamic Random Access Memory (DRAM), and a Static Random Access Memory (SRAM), and the non-volatile storage media may include a hard disk. More particularly, the storage unit 140 may store stereoscopic image data encoded in a specific format.

The input unit 150 generates a key signal corresponding to user manipulation and sends the key signal to the control unit 170. The input unit 150 may include a keypad having alphanumeric and directional keys arranged in a 3*4 or a QWERTY layout, or a touch panel. The input unit 150 may further include a button key, a jog key and a wheel key. The input unit 150 generates an input signal for executing a function of the mobile terminal 100, such as call handling, playback of music, playback of moving images, image display, image capture using a camera, DMB broadcast reception, etc., according to a user action, and sends the input signal to the control unit 170.

The 3D display unit 160 includes a stereoscopic imaging element and a display section. The display section may be realized using Liquid Crystal Display (LCD) devices, Organic Light Emitting Diodes (OLED), or Active Matrix Organic Light Emitting Diodes (AMOLED). The display section visually provides various information, such as menus, input data, and function-setting data, to the user. The display section may output a boot screen, an idle screen, a call handling screen, and other application screens for the mobile terminal 100. The display section may display stereoscopic 3D images, which are received through the wireless communication unit 110 or the DMB module 130 or are stored in the storage unit 140, under the control of an image output controller 175.

The stereoscopic imaging element is placed in front of the display section so that different images may be presented to the left and right eyes of the viewer. More particularly, the stereoscopic imaging element may be a lenticular lens or a parallax barrier. A lenticular lens consists of cylindrical lenticules. When left and right images in the form of a stripe are placed at the focal plane of the lenticular lens, the left and right images are separated according to directions of the lenticules. Hence, the user may view a stereoscopic image without wearing glasses. The width of a lenticule is determined by the width of a pixel in the display, and a single lenticule may be associated with two pixels of the left and right images. To separate the left and right images, the lenticule functions such that the pixel to the left thereof can be seen only by the right eye, and the pixel to the right thereof can be seen only by the left eye.

A parallax barrier consists of slits that block or pass light and are spaced at regular intervals. The left and right images are interlaced in columns on the display and the parallax barrier is positioned so that left and right image pixels can be seen only from particular view points. Hence, the user may experience a stereoscopic effect.

The control unit 170 controls the overall operation of the mobile terminal 100 and controls signal exchange between the internal components thereof. More particularly, the control unit 170 includes a video decoder 171, a line arranger 172, a line interpolator 173, a Left-Right (L-R) image synthesizer 174, and an image output controller 175.

The video decoder 171 decodes encoded 3D image data received through the wireless communication unit 110 or the DMB module 130. The video decoder 171 may also decode encoded 3D image data extracted from the storage unit 140. The encoded 3D image data is decoded into a side-by-side image frame partitioned into a left half and a right half. The side-by-side image frame corresponds to the side-by-side 3D image 603 in FIG. 6. The left half of the side-by-side 3D image includes lines of the left view image 601, and the right half thereof includes lines of the right view image 602. The video decoder 171 forwards the decoded side-by-side 3D image to the line arranger 172.

The line arranger 172 places lines in the left half of the side-by-side 3D image in a left frame (to be a left image), and places lines in the right half thereof in a right frame (to be a right image). More particularly, the line arranger 172 performs line arrangement so that lines in the left half of the side-by-side 3D image become even-numbered lines in the left frame and lines in the right half thereof become odd-numbered lines in the right frame. This corresponds to generation of a side-by-side 3D image, which includes lines selected from the left view image and lines selected from the right view image. After line arrangement, the line arranger 172 forwards the left frame and the right frame to the line interpolator 173.

The line interpolator 173 interpolates existing lines of the left frame and the right frame to generate a left image and a right image. For the left frame, the line interpolator 173 generates odd-numbered lines by interpolating the even-numbered lines to thereby produce a left image including even-numbered lines and odd-numbered lines. For the right frame, the line interpolator 173 generates even-numbered lines by interpolating the odd-numbered lines to thereby produce a right image including odd-numbered lines and even-numbered lines. The line interpolator 173 forwards the produced left image and right image to the L-R image synthesizer 174.

The L-R image synthesizer 174 combines the left image and the right image to generate a reconstructed 3D image. Here, the left image and the right image are the same size, and are combined into a reconstructed 3D image so that line 0 of the left image matches line 0 of the right image and line n of the left image matches line n of the right image. The L-R image synthesizer 174 forwards the reconstructed 3D image to the image output controller 175.

The image output controller 175 controls the 3D display unit 160 to output image data that is stored in the storage unit 140 or is received through the wireless communication unit 110 or DMB module 130. More particularly, upon reception of a reconstructed 3D image from the L-R image synthesizer 174, the image output controller 175 controls the 3D display unit 160 to output the reconstructed 3D image.

Hereinabove, a description is given of the configuration of the mobile terminal 100 capable of processing stereoscopic 3D images. Next, a description is given of a method for processing 3D images in a mobile terminal.

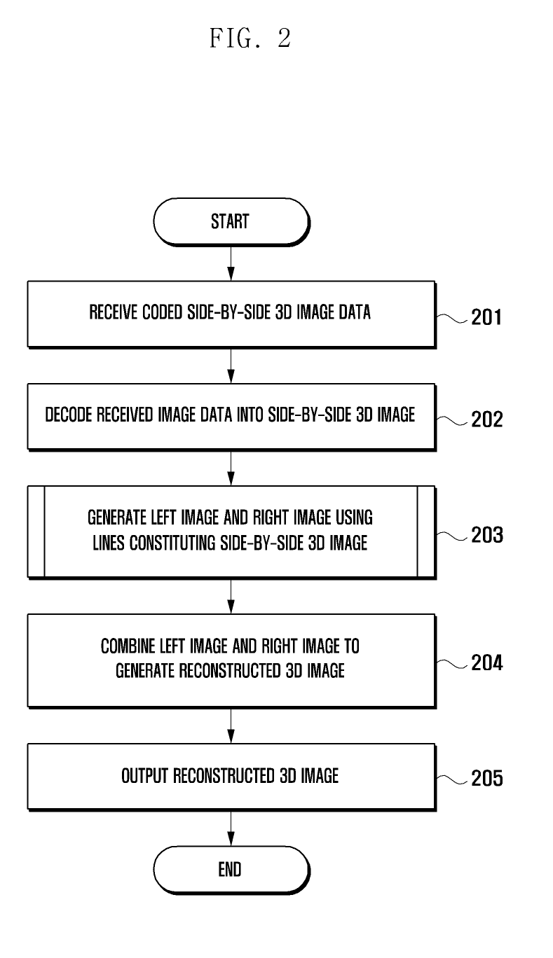

FIG. 2 is a flowchart of a 3D image processing method for a mobile terminal according to an exemplary embodiment of the present invention.

Referring to FIG. 2, a control unit 170 controls the DMB module 130 to receive coded side-by-side 3D image data in step 201. The 3D image data is coded using a specific encoder, such as an H.264 or a DivX encoder. The DMB module 130 forwards the received side-by-side 3D image data to the video decoder 171.

In step 202, the video decoder 171 decodes the received side-by-side 3D image data. Here, the coded side-by-side 3D image data is decoded into a side-by-side 3D image in the form of an image frame partitioned into a left half and a right half. After decoding, the video decoder 171 forwards the decoded side-by-side 3D image to the line arranger 172.

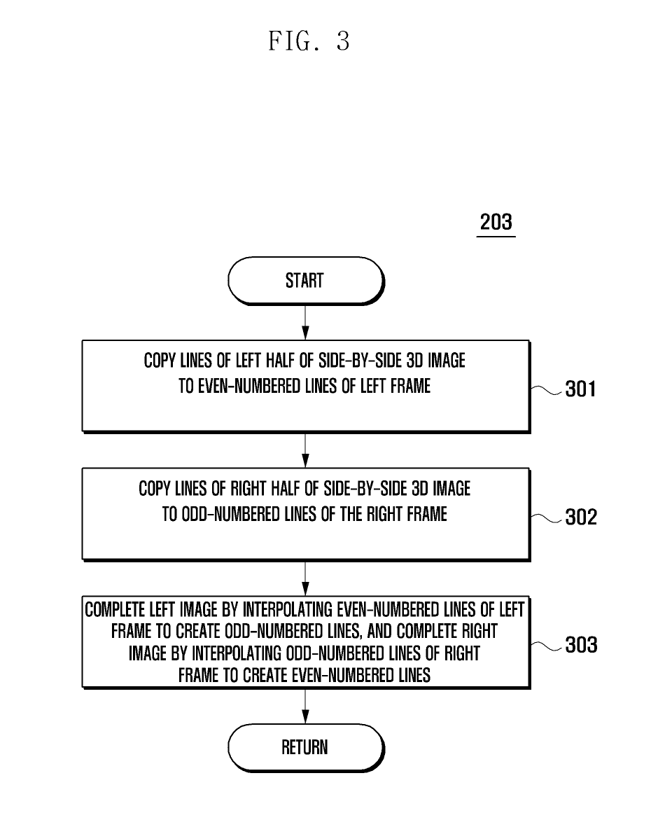

In step 203, the line arranger 172 and the line interpolator 173 generate a left image and a right image using lines constituting the side-by-side 3D image. Step 203 is further described in connection with FIG. 3. The line interpolator 173 forwards the generated left image and right image to the L-R image synthesizer 174.

In step 204, the L-R image synthesizer 174 combines the left image and the right image to generate a reconstructed 3D image. Here, the left image and the right image are the same size and are combined into the reconstructed 3D image so that line 0 of the left image matches line 0 of the right image and line n of the left image matches line n of the right image. The L-R image synthesizer 174 forwards the reconstructed 3D image to the image output controller 175. In step 205, the image output controller 175 controls the 3D display unit 160 to output the reconstructed 3D image.

Exemplary embodiments of the present invention are characterized by step 203 of generating a left image and a right image using lines constituting a side-by-side 3D image.

FIG. 3 is a flowchart of generating left and right images from a side-by-side 3D image according to an exemplary embodiment of the present invention.

Referring to FIG. 3, a line arranger 172 copies lines of the left half of the side-by-side 3D image to even-numbered lines of the left frame in step 301. Here, pixel values of odd-numbered lines of the left frame are set to zero, and pixel values of even-numbered lines thereof are set to pixel values of the lines of the left half of the side-by-side 3D image.

In step 302, the line arranger 172 copies lines of the right half of the side-by-side 3D image to odd-numbered lines of the right frame. Here, pixel values of even-numbered lines of the right frame are set to zero, and pixel values of odd-numbered lines thereof are set to pixel values of the lines of the right half of the side-by-side 3D image. The line arranger 172 forwards the left frame and the right frame to the line interpolator 173.

Alternatively, the line arranger 172 may copy lines of the left half of the side-by-side 3D image to odd-numbered lines of the left frame in step 301, and copy lines of the right half of the side-by-side 3D image to even-numbered lines of the right frame in step 302. Here, lines of the left half of the side-by-side 3D image and lines of the right half of the side-by-side 3D image may be arranged in the left frame and the right frame, respectively, so that the sequence numbers of the lines, extracted from the left half, in the left frame differ by 1 from those of the lines, extracted from the right half, in the right frame.

In step 303, the line interpolator 173 interpolates existing lines of the left frame and the right frame to generate a left image and a right image. Specifically, the line interpolator 173 utilizes even-numbered lines of the left frame as even-numbered lines of the left image, and generates odd-numbered lines of the left image by interpolating the even-numbered lines of the left frame. Hence, the left image includes existing even-numbered lines and newly generated odd-numbered lines. The line interpolator 173 utilizes odd-numbered lines of the right frame as odd-numbered lines of the right image, and generates even-numbered lines of the right image by interpolating the odd-numbered lines of the right frame. Hence, the right image includes existing odd-numbered lines and newly generated even-numbered lines.

The line interpolator 173 forwards the left image and the right image to the L-R image synthesizer 174, which then combines the left image and the right image to generate a reconstructed 3D image.

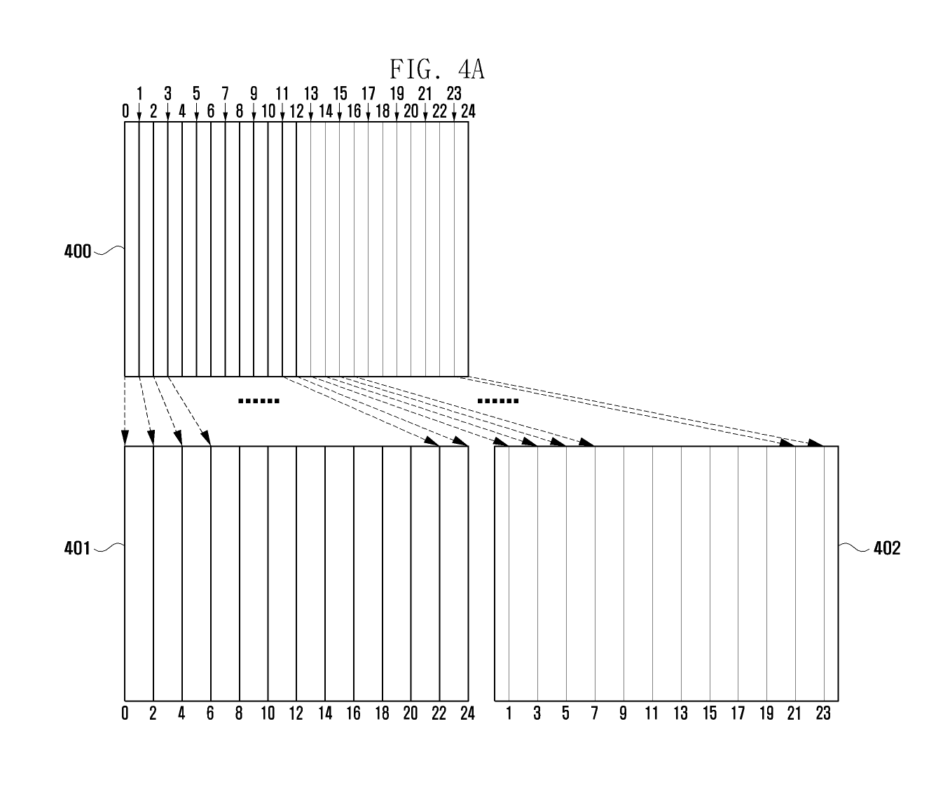

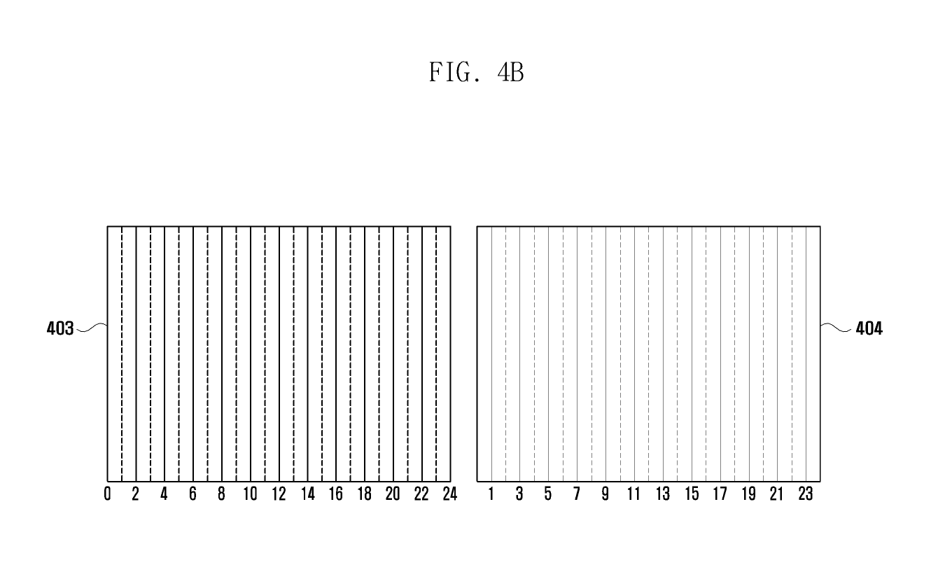

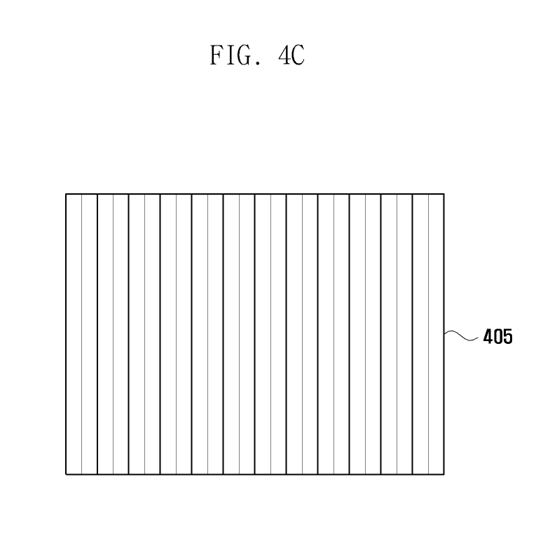

FIGS. 4A and 4B illustrate generation of left and right images from a side-by-side 3D image according to an exemplary embodiment of the present invention.

Referring to FIGS. 4A and 4B, a side-by-side 3D image 400 includes 25 vertical lines. Lines zero to 12 belong to the left half of the side-by-side 3D image 400, and lines 13 to 24 belong to the right half thereof. The line arranger 172 copies lines 0 to 12 (left half) of the side-by-side 3D image 400 to even-numbered lines (0, 2, 4, 6, 8, 10, 12, 14, 16, 18, 20, 22 and 24) of the left frame 401. The line arranger 172 copies lines 13 to 24 (right half) of the side-by-side 3D image 400 to odd-numbered lines (1, 3, 5, 7, 9, 11, 13, 15, 17, 19, 21 and 23) of the right frame 402.

The line interpolator 173 generates odd-numbered lines (1, 3, 5, 7, 9, 11, 13, 15, 17, 19, 21 and 23) of the left frame 401 by interpolating even-numbered lines (0, 2, 4, 6, 8, 10, 12, 14, 16, 18, 20, 22 and 24) of the left frame 401. For example, the 1st line may be generated by averaging the 0th line and the 2nd line. The line interpolator 173 generates even-numbered lines (0, 2, 4, 6, 8, 10, 12, 14, 16, 18, 20, 22 and 24) of the right frame 402 by interpolating odd-numbered lines (1, 3, 5, 7, 9, 11, 13, 15, 17, 19, 21 and 23) of the right frame 402. For example, the 2nd line may be generated by averaging the 1st line and the 3rd line. After interpolation, the line interpolator 173 creates a left image 403 and a right image 404, as in FIG. 4B, utilizing the left frame 401 and the right frame 402, respectively.

The line interpolator 173 forwards the left image and the right image to the L-R image synthesizer 174, which then combines the left image and the right image to thereby generate a reconstructed 3D image.

FIG. 4C illustrates a reconstructed 3D image according to an exemplary embodiment of the present invention.

Referring to FIG. 4C, in reconstructed 3D image 405, odd-numbered lines correspond to the left image and even-numbered lines correspond to the right image.

In the description of step 203 of FIG. 2 with reference to FIGS. 3, 4A, 4B and 4C, the line arranger 172 arranges lines of the left frame and the right frame first, and then the line interpolator 173 performs interpolation using the arranged lines. Alternatively, in step 203, the line arranger 172 may arrange lines of the left frame and the line interpolator 173 may perform interpolation using the arranged lines, and then the line arranger 172 may arrange lines of the right frame and the line interpolator 173 may perform interpolation using the arranged lines.

In an existing method of 3D image processing, to form a left frame and a right frame from a side-by-side 3D image, lines of the left half of the side-by-side 3D image are used to form even-numbered lines of the left frame, and lines of the right half of the side-by-side 3D image are used to form even-numbered lines of the right frame. Then, even-numbered lines of the left frame are interpolated to form odd-numbered lines thereof, and even-numbered lines of the right frame are interpolated to form odd-numbered lines thereof. After interpolation, the left frame and the right frame are used to generate the left image and the right image, respectively. In this case, even-numbered lines of the left image and the right image include lines extracted from the side-by-side 3D image, and odd-numbered lines thereof include lines generated by the mobile terminal 100 through interpolation.

When the left image and the right image as generated above are combined into a reconstructed 3D image, even-numbered lines of the reconstructed 3D image include lines extracted from the side-by-side 3D image, and odd-numbered lines thereof include lines generated by the mobile terminal 100 through interpolation. Compared with the lines extracted from the side-by-side 3D image, the lines generated by the mobile terminal 100 through interpolation may cause image distortion. That is, when odd-numbered lines of the reconstructed 3D image include only lines generated through interpolation, picture quality may be degraded.

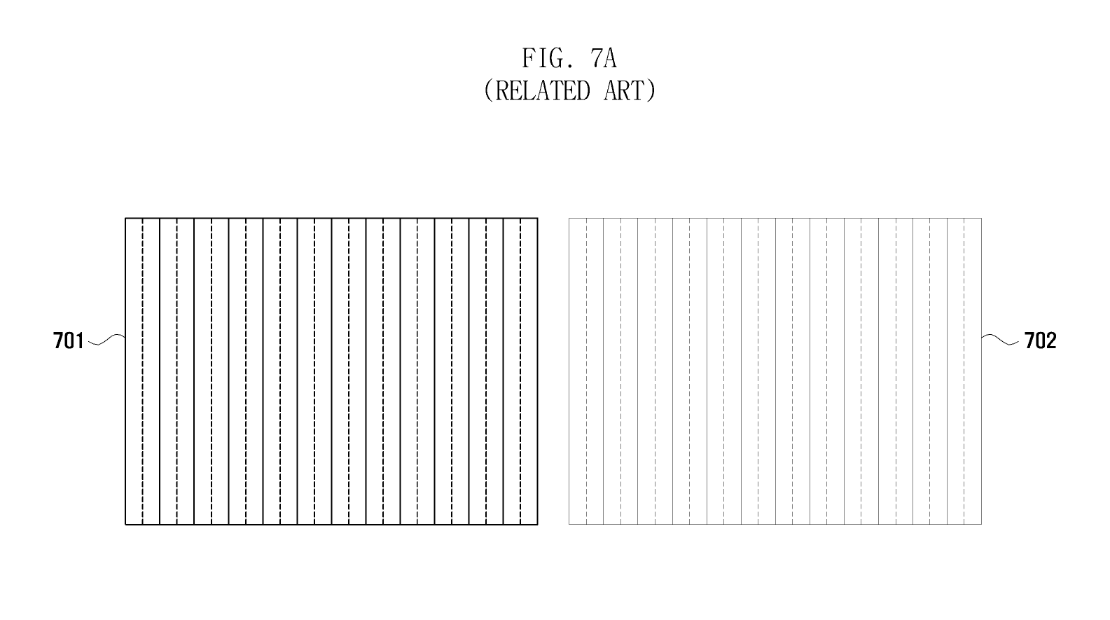

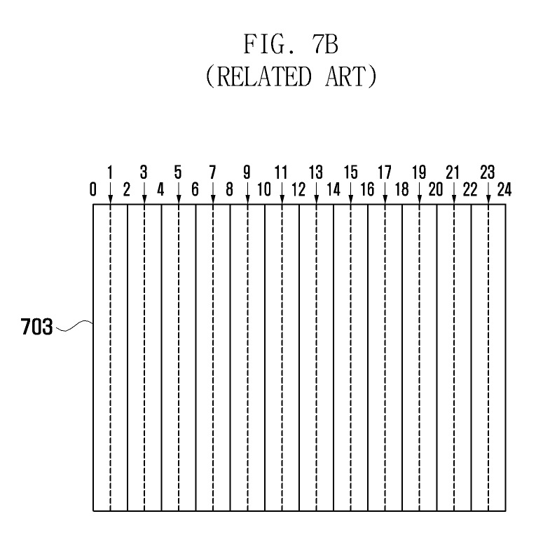

FIG. 7A illustrates left and right images generated according to the related art.

Referring to FIG. 7A, even-numbered lines of the left image 701 include lines extracted from a side-by-side 3D image, and odd-numbered lines thereof include lines generated by the mobile terminal 100 through interpolation. Even-numbered lines of the right image 702 include lines extracted from the side-by-side 3D image, and odd-numbered lines thereof include lines generated through interpolation. The left image 701 and the right image 702 are combined into a reconstructed 3D image as in FIG. 7B.

FIG. 7B illustrates a reconstructed 3D image generated by combining left and right images according to the related art.

Referring to FIG. 7B, even-numbered lines of the reconstructed 3D image 703 include lines extracted from the side-by-side 3D image, and odd-numbered lines thereof include lines generated through interpolation. In this case, whereas the even-numbered lines do not cause image distortion, the odd-numbered lines may cause image distortion. As a result, picture quality of the 3D image may be degraded.

In an exemplary embodiment of the present invention, lines extracted from the side-by-side 3D image are arranged in the right frame in consideration of the sequence numbers of lines extracted from the right view image when a side-by-side 3D image is created. When lines extracted from the right half of the side-by-side 3D image are arranged in the right frame, there exists one-line spacing between each line of the right frame and the corresponding line of the left frame. Hence, all the lines of the reconstructed 3D image include lines extracted from the side-by-side 3D image. That is, as the reconstructed 3D image of the present invention does not include a line generated by interpolation only, picture quality degradation can be prevented.

To verify picture quality improvement, a Peak Signal-to-Noise Ratio (PSNR) was computed as a picture quality metric for an original image, an image reconstructed by an existing method, and an image reconstructed by an exemplary embodiment of the present invention. PSNR is given by Equation 1:

$$PSNR = 10 log \frac{{255}^{2}}{\frac{1}{HV} {\sum }_{i = 0}^{H - 1} {\sum }_{j = 0}^{V - 1} {\vert {I}_{n} ( i , j ) - {\hat{I}}_{n} ( i , j ) \vert}^{2}} , \qquad [ Equation 1 ]$$

where Iₙ(i, j) denotes pixel values of the original image, Îₙ(i, j) denotes pixel values of the reconstructed image, H is the horizontal size of the image, and V is the vertical size of the image.

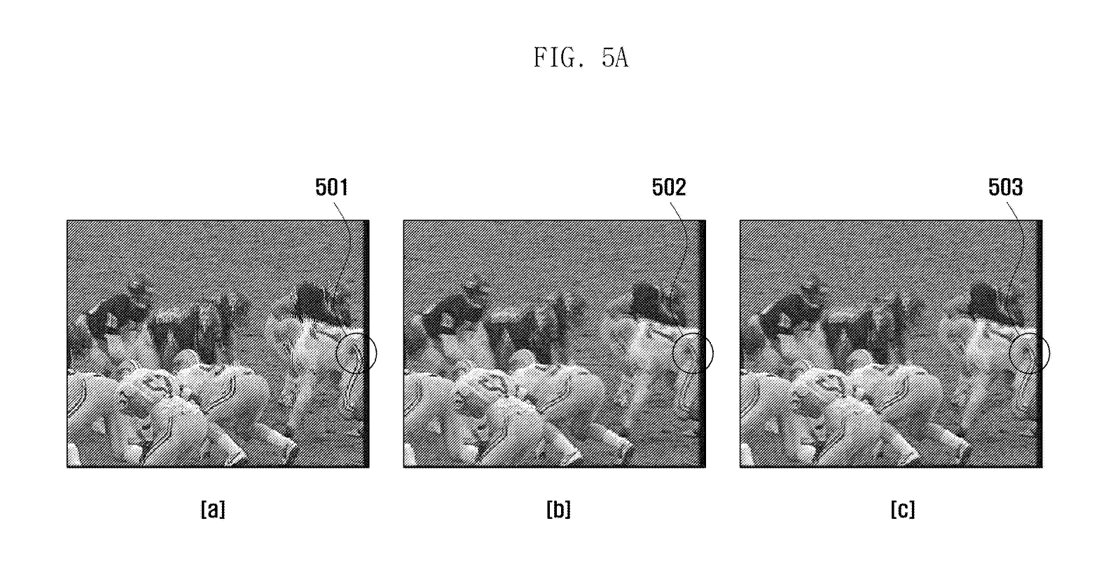

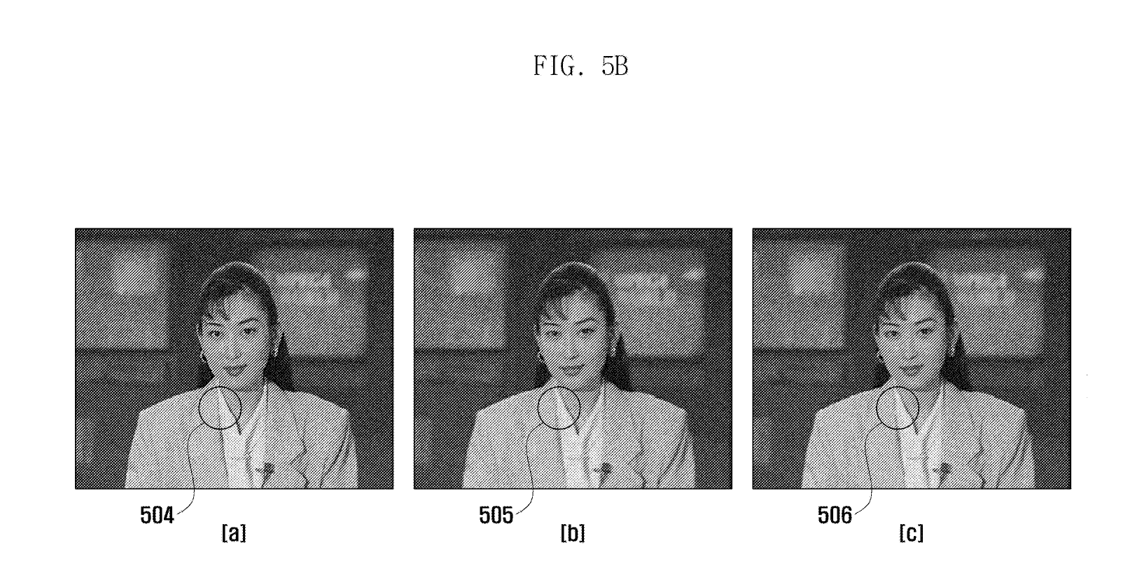

FIGS. 5A and 5B illustrate a comparison between an image reconstructed using a method of the related art and an image reconstructed according to an exemplary embodiment of the present invention.

Referring to FIGS. 5A and 5B, reference symbol [a] indicates the original image, reference symbol [b] indicates the image reconstructed using the existing method, and reference symbol [c] indicates the image reconstructed using an exemplary implementation of the present invention. In FIG. 5A, with reference to a stripe pattern 501 of pants in the original image [a], comparison between a stripe pattern 502 in the reconstructed image [b] and a stripe pattern 503 in the reconstructed image [c] reveals that the stripe pattern 503 is clearer than the stripe pattern 502. PSNR of the reconstructed image [b] is calculated to be 24.02, and PSNR of the reconstructed image [c] is calculated to be 25.17. This confirms that the exemplary implementation of the present invention produces a higher quality image than the method of the related art.

In FIG. 5B, with reference to a zone 504 in the original image [a], comparison between a zone 505 in the reconstructed image [b] and a zone 506 in the reconstructed image [c] reveals that the boundary between the neck and shirt and the boundary between the shirt and jacket in the zone 506 are clearer than that of zone 505. PSNR of the reconstructed image [b] is calculated to be 32.73, and PSNR of the reconstructed image [c] is calculated to be 33.16. This confirms that the exemplary implementation of the present invention produces a higher quality image than the method of the related art.

The exemplary implementation for processing 3D images may be implemented as a computer program and may be stored in various computer readable storage media. The computer readable storage media may store program instructions, data files, data structures and combinations thereof.

The computer readable storage media may include a magnetic media, such as a hard disk and a floppy disk, an optical media, such as a Compact Disk-Read Only Memory (CD-ROM) and a Digital Video Disc (DVD), a magneto-optical media, such as an optical disk, and memory devices, such as a ROM and a RAM. The program instructions may include machine codes produced by compilers and high-level language codes executable through interpreters.

While the present invention has been shown and described with reference to certain exemplary embodiments thereof, it will be understood by those skilled in the art that various changes in form and details may be made therein without departing from the spirit and scope of the present invention as defined in the appended claims and their equivalents.

What is claimed is:

1. A method for processing 3 Dimensional (3D) images in a mobile terminal, the method comprising:
receiving a side-by-side 3D image including vertical lines of pixels;
generating a left frame to form a left image and a right frame to form a right image by copying lines of the left half of the side-by-side 3D image to even-numbered lines of the left frame and copying lines of the right half of the side-by-side 3D image to odd-numbered lines of the right frame;
completing the left image and the right image by interpolating existing lines of the left frame and the right frame; and
generating a 3D image frame by combining the left image and the right image, and displaying the 3D image frame.

2. The method of claim 1, wherein the generating of the left frame and the right frame comprises:
setting pixel values of odd-numbered lines of the left frame to zero and copying pixel values of lines of the left half of the side-by-side 3D image to pixels of even-numbered lines of the left frame; and
setting pixel values of even-numbered lines of the right frame to zero and copying pixel values of lines of the right half of the side-by-side 3D image to pixels of odd-numbered lines of the right frame.

3. The method of claim 1, wherein the completing of the left image and the right image comprises:
generating odd-numbered lines of the left frame utilizing even-numbered lines of the left frame; and
generating even-numbered lines of the right frame utilizing odd-numbered lines of the right frame.

4. The method of claim 1, wherein the 3D image frame is displayed using a stereoscopic imaging element of a display unit.

5. The method of claim 4, wherein the stereoscopic imaging element is placed in front of the display unit to present different images to the left eye and the right eye of a viewer.

6. The method of claim 1, wherein the left image and the right image are the same size.

7. A mobile terminal capable of processing 3 Dimensional (3D) images, the mobile terminal comprising:
a display unit for displaying a 3D image;
a line arranger for generating, for a side-by-side 3D image including vertical lines of pixels, a left frame to form a left image and a right frame to form a right image by copying lines of the left half of the side-by-side 3D image to even-numbered lines of the left frame and for copying lines of the right half of the side-by-side 3D image to odd-numbered lines of the right frame;
a line interpolator for completing the left image and the right image by interpolating existing lines of the left frame and the right frame;
a Left-Right (L-R) image synthesizer for generating a 3D image frame by combining the left image and the right image; and
an image output controller for controlling the display unit to display the generated 3D image frame.

8. The mobile terminal of claim 7, wherein the line arranger sets pixel values of odd-numbered lines of the left frame to zero, copies pixel values of lines of the left half of the side-by-side 3D image to pixels of even-numbered lines of the left frame, sets pixel values of even-numbered lines of the right frame to zero, and copies pixel values of lines of the right half of the side-by-side 3D image to pixels of odd-numbered lines of the right frame.

9. The mobile terminal of claim 7, wherein the line interpolator generates odd-numbered lines of the left frame utilizing even-numbered lines of the left frame, and generates even-numbered lines of the right frame utilizing odd-numbered lines of the right frame.

10. The mobile terminal of claim 7, wherein the display unit for displaying the 3D image includes a stereoscopic imaging element and a display section.

11. The mobile terminal of claim 10, wherein the stereoscopic imaging element is placed in front of the display unit to present different images to the left eye and the right eye of a viewer.

12. The mobile terminal of claim 11, wherein the stereoscopic imaging element comprises at least one of a lenticular lens and a parallax barrier.

13. The mobile terminal of claim 7, wherein the left image and the right image, combined by the L-R image synthesizer to generate a reconstructed 3D image, are the same size.
